(19) United States
(12) Patent Application Publication
(10) Pub. No.: US 2005/0173191 A1
(43) Pub. Date: Aug. 11, 2005

(54) Truck engine compartment ladder

(76) Inventor: Jacob Byron Linzmayer, Gainesville, FL (US)

Correspondence Address: Frank B. Arenas, 2327 Taylor Ave., P.O. Box 600, Coleman, FL, 33521, US

(21) Appl. No.: 10/773,981

(22) Filed: Feb. 6, 2004

(51) Int. Cl. E06C 5/00

(52) U.S. Cl. 182/127

(57) ABSTRACT

An truck engine compartment ladder comprising a body with at least one vertical member of sufficient strength, length, width and depth to accomplish support of the weight of an average or above average person, fixed or pivoted step(s) of at least one horizontal member of sufficient strength, length, width and depth to accomplish support of the weight of an average or above average person, and an attachment means employed for attaching the ladder (either permanently or temporarily) to the truck frame (chassis) sufficient to accomplish support of the weight of an average or above average person. The ladder allows access to the truck engine compartment, front area of the truck, front components of the truck, windshield(s), windshield wiper(s) and top running light(s) of trucks, including tractor(s) (tractor(s) not connected and when connected to trailers), tractor-trailers and tractor-trailer-type trucks.

### BACKGROUND OF THE INVENTION

1. Field of the Invention

The present invention relates generally to ladders used by operators of large trucks. The invention particularly relates to ladders used on tractor-trailer type trucks, as they are commonly referred to in the trucking industry. The invention more particularly relates to ladders used to access the truck engine compartment, front area of the truck, front components of the truck, windshield(s), windshield wiper(s) and top running light(s) of trucks, including but not limited to tractor(s) (tractor(s) not connected and when connected to trailer(s)), tractor-trailers and tractor-trailer-type trucks (sometimes known in the United States as Class 8 type trucks). Note: (s) denotes either singular or plural.

2. Description of the Prior Art

Ladders have been used regularly on trucks for access to the inside, top, and outside of the truck cab, truck bed or truck-trailer for many years. Truck engine compartments, however, have been lacking in a ladder usable to allow the operator or mechanic access to the engine for inspection or servicing. Additionally, the trucking industry lacks a convenient means for an operator or mechanic to access the truck windshield and other components on the front of the truck. This is especially important for safety reasons. Driving in inclement weather requires cleaning of the truck windshield often to ensure clear driver vision of the road ahead and avoid accidents. None of the prior art addresses or solves this problem. This new and useful truck engine compartment ladder invention solves these trucking industry problems in a safe and economical manner.

### SUMMARY OF THE INVENTION

It is an object of the invention to help prevent truck accidents by allowing operators and mechanics safe and easy access to the truck windshield(s), windshield wiper(s), top running light(s) and other front areas of trucks for cleaning, repair, service, modification, fabrication or maintenance prior to operation.

It is another object of the invention to allow truck operators or mechanics to gain safe and easy access to the top of the truck engine and engine compartment for cleaning, maintenance, service, modification, rebuilding, fabrication or repair.

It is a further object of the present invention to allow the ladder to be functional with minimal input from the operator regardless of desired location on or in the truck engine compartment, chassis or frame.

The objects of this invention are achieved and the present invention provides a new and useful article of manufacture and method for use comprising an truck engine compartment ladder, (the preferred embodiment of which is disclosed in all 8 drawings and Figures) which can be integrated into, attached or used anywhere in or on the truck engine compartment but preferably integrated into or attached to the truck chassis or frame.

This invention is compact and of simple construction that is easy to make and use.

### BRIEF DESCRIPTION OF THE DRAWINGS

FIG. 1 is a front view of the truck engine compartment ladder.

FIG. 2 is a left side view of the truck engine compartment ladder.

FIG. 3 is a perspective view of the front of the truck engine compartment ladder.

FIG. 4 is a back view of the truck engine compartment ladder.

FIG. 5 is a right side view of the truck engine compartment ladder.

FIG. 6 depicts a view of the truck engine compartment ladder attached to the truck frame (chassis) with step(s) pivoted open and depicts the typical method of use of the truck engine compartment ladder.

FIG. 7 is a front view of the truck engine compartment ladder with the steps pivoted closed and retainer lock(s) engaged to reduce the side profile of the invention.

FIG. 8 is a left side view of the truck engine compartment ladder with the step(s) pivoted closed and the retainer lock(s) engaged to reduce the side profile of the invention.

### DETAILED DESCRIPTION OF THE PREFERRED EMBODIMENT

The apparatus of the invention is conveniently fabricated by conventional and standard methods using conventional and standard materials common in the trucking and metal fabrication industries.

For example, the truck engine compartment ladder (“the ladder”) may be fabricated from aluminum, stainless steel or like metals or any other suitable material. The ladder may also be fabricated from non-metallic materials for lighter weight and corrosion resistance. Theses non-metallic materials include, among others, conventional polymers such as, for example, polystyrene, polycarbonate, polyurethane, polyethylene, phenol formaldehyde resins, polybutylene, Teflon and the like. The ladder and attachment means employed for attaching the ladder to the truck may be made of any of the above-referenced materials or additionally any type of strap, wire, cord, line, rope or webbing using Dacron, Spectra, nylon and similar materials, among others. These above-mentioned materials are examples and do not limit the types of materials that can be used to make and use the ladder; any and all suitable materials may be used. The components of the ladder may be integrated together by standards means such as welding, bolting, gluing, riveting, sewing or any other suitable means. The ladder may also be completely flexible, such as like a rope-ladder.

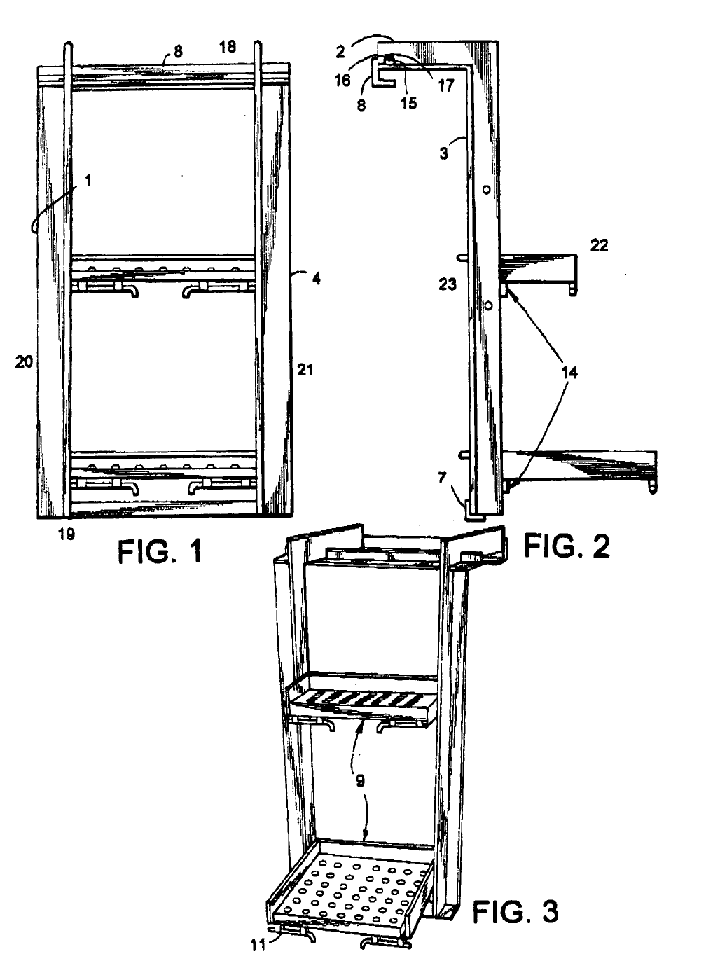

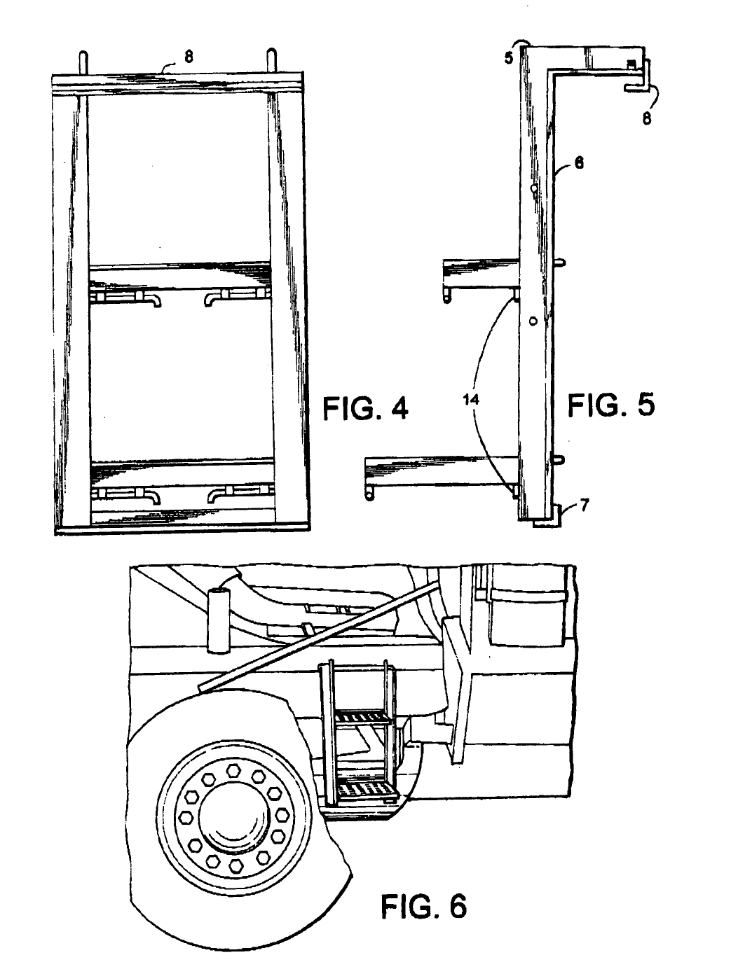

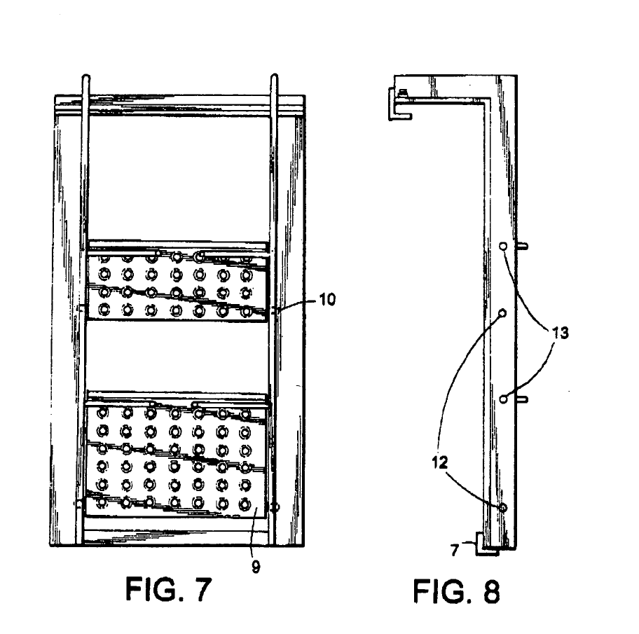

The apparatus and method of using the invention will now be further described and exemplified by reference to the various specific embodiments set forth in the drawings. FIG. 1 through FIG. 8 are views of the preferred embodiment and best mode of the invention.

Again referring to all Figures, the assembly and fabrication of the preferred embodiment of the invention will be described in detail. The ladder is assembled and fabricated from standard materials and methods now used in the appropriate industries. Typically, the ladder is an aluminum body and step(s) either solidly connected or pivotally connected to the body. The body is at least one vertical member of sufficient strength, length, width and depth to accomplish support of the weight of an average or above average person. The step(s) are at least one horizontal member sufficiently integrated into the vertical member of sufficient strength, length, width and depth to accomplish support of the weight of an average or above average person. Optionally, the steps may be made of slip-resistant design such as serrated teeth integrated into the top surface of the step(s). Or, a slip-resistant finish may be applied to the top surface of the step(s). The attachment means employed for attaching the ladder to the truck is sufficient to accomplish support of the weight of an average or above average person. Though the attachment means may be located anywhere on the ladder, the preferred attachment means is a hook-shaped rigid top of the vertical member(s) to hook onto and hang from the truck frame (chassis) for support. The ladder is typically fabricated from aluminum, machined using conventional machine-shop techniques such as drilling, cutting, smoothing, welding, bolting and polishing. The ladder is shown with its design, functional aspects and relationship of components in scalable form in all of the drawings combined.

Now the method of making the ladder in the preferred embodiment and best mode will be described in detail. Referring to all of the drawings, first, suitable metal angle stock is cut to the appropriate length and welded together to form the left rail 1 from the cut metal angle pieces of the left top rail 2 and the left side rail 3. The right rail 4 is similarly fabricated from the cut metal angle pieces of the right top rail 5 and the right side rail 6. Both rails are placed parallel to each other on a work table with the top rails vertically oriented, held by temporary clamps if necessary. Then, another piece of suitable metal angle stock is cut to the appropriate length to form the bottom support 7 and welded perpendicular to and connecting the bottom ends of the two parallel left 1 and right 4 rails. Another piece of suitable metal angle stock is cut to the appropriate length to form the rear frame retainer 8 and welded perpendicular to and connecting the ends of the left and right top rails (2 & 5), making a rigid body of all welded pieces. The step(s) 9 are made from suitable metal angle cut and welded to make a rectangular step-base and non-slip metal plate welded on top of the rectangular step-base. Pivot pin(s) 10 are welded on at the back of the step(s) 9 and upright retainer lock(s) 11 are welded on at the front of the step(s) 9. The step pivot hole(s) 12 and upright retainer hole(s) 13 are drilled into the side rails (3 & 6) at the appropriate locations and the step(s) 9 with pivot pin(s) 10 are integrated into the step pivot hole(s) 12 with rotational freedom. The step support(s) 14 are cut from suitable metal flat stock and welded perpendicular to and onto the side rails (3 & 6) in the proper location(s). Next, the tightening bolt hole(s) 15 are drilled into the top rails (2 & 5) in the proper location and the tightening nut(s) 16 are tacked welded directly on top of and in line with the tightening bolt hole(s) 15. The tightening bolt(s) 17 (preferably with wing-nut type heads for hand tightening) are inserted and threaded into and the tightening nut(s) 16. To make clear the above-referenced orientations (top, bottom, left, right, front and back) of the ladder, FIG. 1 is labeled top 18, bottom 19, left 20, right 21 and FIG. 2 is labeled front 22 and back 23.

To use the ladder in the preferred embodiment and best mode, it is unstowed and attached by the operator to the truck frame or chassis by hanging the hook-shaped rigid top rail(s) (2 & 5) and rear frame retainer 8 onto and hang from the truck frame (chassis) for support, then the tightening bolt(s) 17 tightened to secure the attachment. The upright container lock(s) 11 are withdrawn from the upright retainer holes 13 and the step(s) 9 are rotated (90) ninety degrees from vertical to horizontal orientation and contact the step support(s) 14. This is depicted in FIG. 6 in the “steps open” mode. The operator then climbs the step(s) 9 for access to the truck engine, truck engine compartment and other front area of the truck. Once access is achieved by the foregoing, the operator reverses the above-described sequence of use to remove and stow the ladder. One embodiment may have steps rigidly attached to the rail(s) and always remain “open.” Alternately, the ladder may be permanently attached to the truck frame (chassis) with either non-movable step(s) already in the open position for use or step(s) that pivot and may be closed or opened for use as needed as previously described. In another embodiment, only one vertical rail may be used for support of at least one step (either fixed or pivotal step(s) integrated into the vertical rail with rotational freedom from about (0) zero degrees (vertical) to about (90) ninety degrees (horizontal) as previously described) to effect a more narrow and thinner ladder profile for use in smaller truck engine compartments.

As will be apparent to persons skilled in the art, such as a truck driver, truck driver with a United States Commercial Driver's License (CDL), truck mechanic, welder or machinist, various modifications and adaptations of the structure and method of use above-described will become readily apparent without departure from the spirit and scope of the invention, the scope of which is defined in the claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention are well known by those skilled in the art. Instead, the invention is limited and defined solely by the following claims.

The present embodiment is therefore to be considered in all respects as illustrative and not restrictive, the scope of the invention being indicated by the following claims rather than by the foregoing description, and all changes which come within the meaning and range of equivalency of the claims are therefore intended to be embraced therein.

1. An article of manufacture (truck engine compartment ladder) comprising:
at least one vertical or nearly vertical member, and;
at least one horizontal or nearly horizontal member integrated into the vertical member to further comprise at least one step, and;
an attachment means integrated into the vertical member such that when the vertical member is attached via the attachment means into, in or on a truck engine compartment at an appropriate location, the vertical or nearly vertical and horizontal or nearly horizontal members function as a ladder with at least one step to allow an operator to climb up and access the truck engine compartment, truck engine, truck windshield(s), windshield wiper(s), top running light(s) and other front areas of the truck.

2. The ladder of claim 1 wherein the horizontal or nearly horizontal member comprising the step has a non-slip surface disposed on or into the top surface.

3. The ladder of claim 1 wherein the horizontal or nearly horizontal member comprising the step is pivotally integrated into the vertical or nearly vertical member with rotational freedom of about 90 degrees of arc to allow the horizontal or nearly horizontal member to rotate up parallel or nearly parallel to the vertical or nearly vertical member and the step has a means for locking and unlocking the step into or from the vertical or nearly vertical position.

4. The ladder of claim 1 wherein the attachment means is either permanent or temporary.

5. A method of using a truck engine compartment ladder, said method comprising the steps of:
(a) attaching the ladder of claim 1 via the attachment means into, in or on a truck engine compartment at an appropriate location, either permanently or temporarily and;
(b) climbing the ladder of claim 1 to access the truck engine compartment, truck engine, truck windshield(s), windshield wiper(s), top running light(s) and other front areas of the truck.
